(19) United States
(12) Patent Application Publication
(10) Pub. No.: US 2023/0104649 A1
(43) Pub. Date: Apr. 6, 2023

(54) Off-Platform Cable Presentation Rig

(71) Applicant: Government of the United States, as represented by the Secretary of the Air Force, Wright-Patterson AFB, OH (US)

(72) Inventors: Tabitha Wells, Waddell, AZ (US); Christopher Pillsbury, Lancaster, CA (US)

(21) Appl. No.: 17/958,325

(22) Filed: Oct. 1, 2022

Related U.S. Application Data
(60) Provisional application No. 63/251,731, filed on Oct. 4, 2021.

(51) Int. Cl. H01R 43/28; H02G 3/04

(52) U.S. Cl. CPC H01R 43/28; H02G 3/0487

(57) ABSTRACT

Various embodiments comprise systems, mechanisms, and apparatus configured to enable off-platform presentation of a cable assembly for prior to platform installation of the cable assembly. An apparatus according to one embodiment comprises: an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and a retention assembly, configured to secure the cable assembly to the first surface in a manner allowing mechanical manipulation of the cable assembly; wherein the cable assembly is configured for platform installation when secured to the first surface such that cable connections and corresponding apertures are operatively aligned.

Pursuant to 37 C.F.R. § 1.78(a)(4), this application claims the benefit of and priority to prior filed co-pending Provisional Application Ser. No. 63/251,731, filed Oct. 4, 2021, which is expressly incorporated herein by reference.

### RIGHTS OF THE GOVERNMENT

The invention described herein may be manufactured and used by or for the Government of the United States for all governmental purposes without the payment of any royalty.

### FIELD OF THE DISCLOSURE

The present disclosure generally relates to complex installations of cable assemblies in platforms such as airframes and, in particular, a mechanical rig configured to enable off-platform presentation of cabling prior to platform installation of such cabling.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Cable assemblies may comprise highly complex groupings of electrical wiring, fiberoptic strands/cables, in-line modules performing electrical, optical, and/or mechanical functions, and/or other components. Complex and often fragile cable assemblies may be used in electrical, mechanical, or environmentally challenging environments, such as high performance aviation, marine, battlefield or other environments/applications. As such, carefully considered installation of cable assemblies is critical.

During the manufacture of a high performance aircraft or other platforms, it is important to ensure that various cable assemblies are installed in a manner providing both functional performance and environmental resilience; the installed cable assemblies must perform their intended functions while subjected to extreme forces, temperatures, and so on. Such installation is a challenge under any circumstances, and requires strict adherence to the tight space allocations, cable pre-stressing or pre-loading to ensure correct physical presentation of the cable assembly to the airframe mounting points, and so on.

The process of installing such cabling is difficult during initial manufacture of an airframe or other platform. The process of replacing such cabling in the field is even more difficult and time-consuming, typically requiring a slow and deliberate process with multiple field personnel cooperating to install the cable assembly in the airframe or other platform after retrieving/unpacking the replacement cable assembly from its shipping container. Installation consists of physically manipulating the unpacked cable assembly to enable testing the various connections/subsystems (if field testing is available), then physically maneuvering the cable assembly into position on the airframe or other platform while making the appropriate service connections and mounting connections. The process is imprecise, and generally consists of doing whatever is necessary to ensure that the cable assembly is arranged in substantially the same manner as the cable assembly being replaced. If the installation is not correct, then the entire cable assembly needs to be removed from the airframe or other platform and the installation process repeated. This is a common occurrence. This process can take many hours for large cable assemblies, and there are many opportunities for mistakes to be made.

### SUMMARY

Various deficiencies in the prior art are addressed by systems, mechanisms, and apparatus configured to enable off-platform presentation of a cable assembly for prior to platform installation of the cable assembly. An apparatus according to one embodiment comprises: an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and a retention assembly, configured to temporarily secure the cable assembly to the retention assembly in a manner allowing mechanical manipulation of the cable assembly; wherein the cable assembly is configured for platform installation when secured to the first surface such that cable connections and corresponding apertures are operatively aligned.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a cable assembly presentation apparatus according to an embodiment;

FIG. 2 depicts the cable assembly presentation apparatus of FIG. 1 with a cable assembly mounted thereon;

FIG. 3 depicts a mechanism for pivotally mounting a cable assembly retention mechanism to the cable assembly presentation apparatus of FIGS. 1; and

FIG. 4 depicts a locking mechanism suitable for use with the cable assembly retention mechanism of FIG. 3.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity of illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

Various embodiments provide an apparatus configured to enable off-platform presentation or orientation of a cable assembly prior to installation of the cable assembly on the platform. The apparatus may comprise an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and a retention assembly, configured to temporarily secure the cable assembly to the first surface in a manner allowing mechanical manipulation of the cable assembly; wherein the cable assembly is configured for platform installation when secured to the first surface such that cable connections and corresponding apertures are operatively aligned.

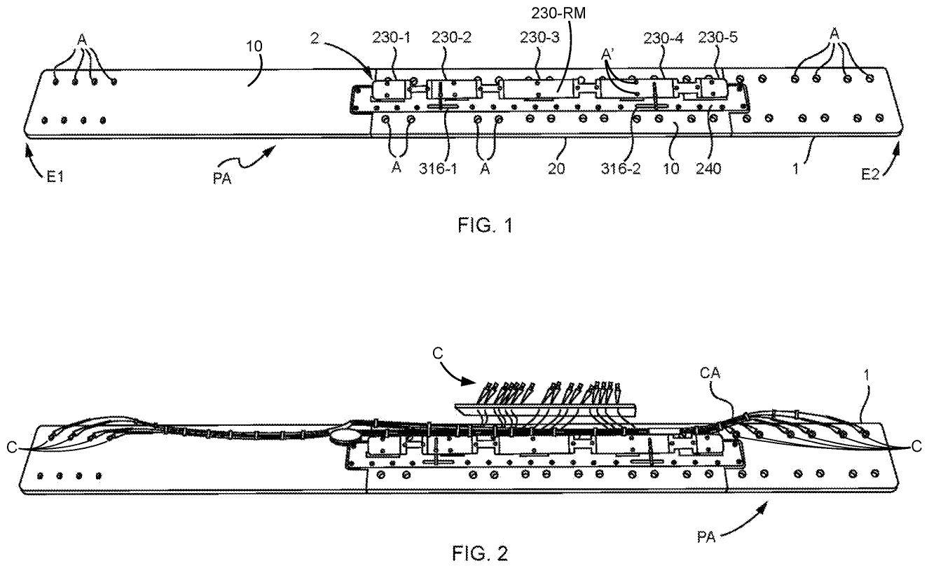

FIG. 1 depicts a cable assembly presentation rig, apparatus, or system according to an embodiment. FIG. 2 depicts the cable assembly presentation rig, apparatus, or system of FIG. 1 with a cable assembly mounted thereon. The cable assembly presentation apparatus PA of FIGS. 1-2 comprises an elongated and substantially planar body 1 having a first or top surface 10 disposed between proximal E1 and distal E2 ends of the body 1 and configured to receive thereupon the cable assembly CA. The body 1 may be formed of any rigid material such as polymers, carbon fiber, wood, metal, and/or a combination thereof. The first or top surface 10 of the body 1 has formed therethrough (e.g., via drilling, punching, etc.) a plurality of apertures A arranged in accordance with a spacing of service connections C for the cable assembly CA. The body 1 may also comprise a second or bottom surface 20 substantially coplanar with respect to the first or top surface 10.

One embodiment depicted in FIGS. 1-2 comprises a substantially rigid body formed in a plank-like shape and having a length of about 6 feet and a width of about 2.5 feet. The apertures A are formed by drilling or punching operations in accordance with the locations of service connectors associated with the particular cable assembly CA depicted in FIG. 2.

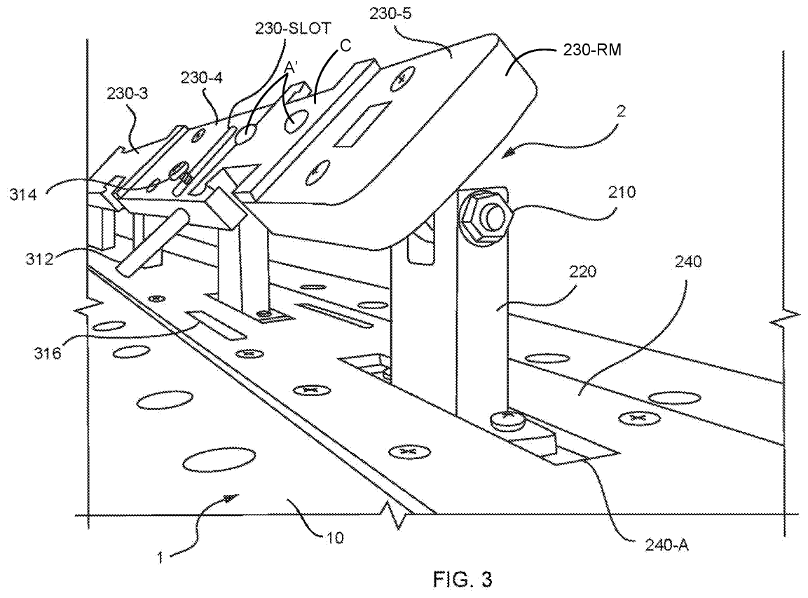

The cable assembly presentation apparatus PA further comprises a retention assembly 2 mounted on the first or top surface 10 of the body 1 and operable to receive and temporarily secure the cable assembly CA to the body 1, whereupon the service connections C of the cable assembly CA may be splayed or otherwise arranged/aligned with corresponding apertures A, as depicted in FIG. 2. It is noted that the retention assembly 2 may be mounted directly to the body 1, or to a rigid material base plate 240 that is mounted to the first or top surface 10 of the body 1, or by some other means. Referring to FIG. 3, a retention assembly 2 comprises a plurality of top portions 230 (shown as top portions 230-1 through 230-5) configured to receive a cable assembly mounted thereon. The top portions 230 are pivotably mounted to the front or top surface 10 of the body 1 by a respective plurality of standoffs 220 including pivot mechanisms 210 such that the top portions 230 of the retention assembly 2 may be rotated above the first or top surface 10 of the body 1 from, illustratively, a co-planar attitude with respect to the top surface 10 to some angle between 0 and 90 degrees of the co-planar attitude.

The retention assembly 2 may optionally include a base plate 240 mounted to the front or top surface 10 of the body 1. The base plate portion may include apertures 240A (as shown) located to receive the standoffs 220 such that the standoffs 220 may be secured directly to the front or top surface 10 of the body 1. In some embodiments, the standoffs 220 mount directly to the base plate 240 such that only the base plate 240 is secured directly to the front or top surface 10 of the body 1.

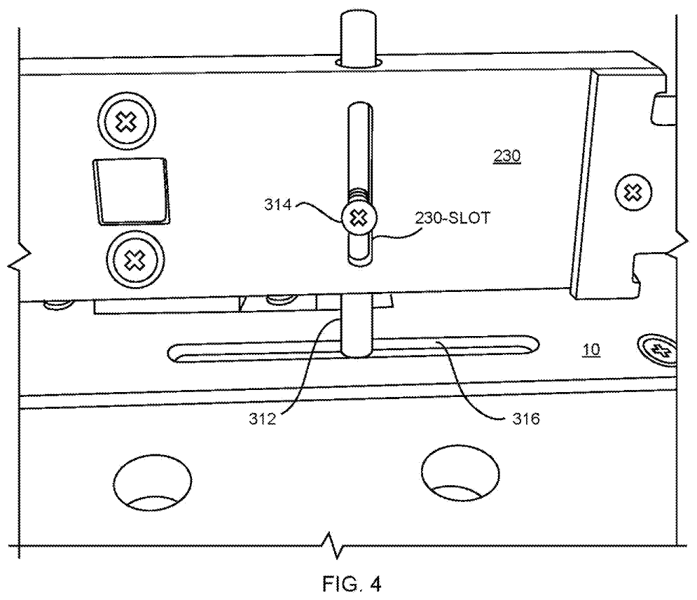

FIG. 4 depicts a locking mechanism suitable for use with the cable assembly retention mechanism of FIG. 3. Specifically, the retention assembly 2 may optionally include one or more locking mechanisms by which the top portions 230 of the retention assembly 2 (and cable mounted thereto) may be locked into a 90 degree rotated position. Specifically, FIGS. 2-3 depict a locking assembly comprising a rod 312 slidably engaged within a slot 230-SLOT formed in one or more top portions 230 of the retention assembly 2 (illustratively top portions 230-2 and 230-4). A grasping protrusion 314 coupled to the rod 312 allows the rod to be moved within the slot 230-SLOT to the top portions 230 of the retention assembly, as well as moved such that a protruding end of the rod 312 may be extended into a slot 316 formed in the base plate 240 or in the front or top surface 10 of the body 1. In this manner, a cable assembly may be locked into a rotated position by service personnel.

The retention assembly 2 may be further configured to not only hold the cable assembly CA to the body 1, but to do so in a manner substantially simulating the exact position of a correctly installed cable assembly CA. That is, the retention assembly 2 is configured to secure the cable assembly CA in a manner that causes the secured cable assembly CA to be positioned in an “installed” shape wherein mechanical stresses imparted to the cable assembly CA approximate the mechanical stresses that the cable assembly CA will be subject to when properly installed in an airframe or other platform. The retention assembly 2 may be configured to hold the cable assembly CA at the same mounting locations and/or with the same mounting mechanisms as would be used to secure the cable assembly CA to an airframe or other platform.

In various embodiments, the retention assembly 2 has formed therethrough (e.g., via drilling, punching, etc.) a plurality of apertures A′ arranged in accordance with a spacing of cable mounting connections suitable for securing the cable assembly CA to the retention assembly 2 such that the cable assembly CA may be readily manipulated to a desired service orientation. Further, the retention assembly 2 may be configured with multiple sets of apertures A′ arranged in accordance with a spacing of service connections C of two cable assemblies CA such that multiple cables may be contemporaneously manipulated to a desired service orientation.

The retention assembly 2 may be implemented as a substantially rectilinear component (e.g., such as depicted in the figures) or plurality of components, a cylindrical component, or a component of some other shape. Generally speaking, the retention assembly 2 is an elongated retention member 230-RM oriented in a direction parallel to the length of the base 1 and extending along at least a portion of the length of the base 1. In some embodiments, the retention assembly 2 is positioned on the base at a location approximately balancing a mass of a cable assembly secured thereon. In some embodiments, the retention assembly 2 comprises a minimum length of approximately 20% to 50% of the length of the base 1.

As depicted in the figures, the retention assembly 2 comprises a retention member 230-RM configured to receive cables running parallel to the length of the retention member 230-RM. However, it is noted that the retention member 230-RM may be configured to receive cables extending beyond one or both ends of the retention member 230-RM.

As depicted in the figures, the retention assembly 2 comprises a retention member 230-RM pivotably connected to the base 1. Specifically, one end of the retention member 230-RM is secured to the base 1 by a mechanism enabling the retention assembly 2 to pivot about that one end such that the other end of the retention assembly 2 may be moved out and away from the base 1 to thereby displace a cable assembly (or multiple cable assemblies) currently secured to the base 1.

As depicted in the figures, the retention assembly 2 is made of rigid materials such as metal, polymer, and other rigid materials. Further, in a multi-segment embodiment, the base plate 240 may be used to secure the multiple segments 230 of the body 1 to form an assembled embodiment. Referring to FIG. 1, each segment 230 comprises an elongated retention member 230-RM and is separated from any adjacent segment via a portion of the retention assembly configured for making a service connection C.

Thus, the cable assembly presentation apparatus PA is configured hold a cable assembly CA in a manner imparting thereto any pre-stresses appropriate to the ultimate installation, wherein the service connections C of the cable assembly CA are aligned with corresponding apertures A. The cable assembly CA may then be removed from the cable assembly presentation apparatus PA and installed on the airframe or other platform directly. Alternatively, the cable assembly CA may be installed in the airframe or other platform by elevating and/or aligning the cable assembly presentation apparatus PA with the appropriate installation location on the airframe or other platform such that the service connections and mounting connections of the cable assembly are aligned with, respectively, corresponding service plugs/receptacles and corresponding mounting mechanisms of the airframe or other platform. After connecting the service connections of the cable assembly to the corresponding plugs/receptacles, and connecting the cable assembly mounting connections to the corresponding mounting mechanisms, the retention assembly 2 is operated to release the cable assembly CA and the cable assembly presentation apparatus PA is withdrawn from its position adjacent to the airframe or other platform, such as where the cable assembly presentation apparatus PA was used to elevate and/or align the cable assembly CA directly to an installation location on the airframe or other platform.

In some embodiments, the body 1 comprises a single substantially rigid plank or board, whereas in other embodiments it may comprise two or more sections mechanically coupled to each other via hinges or other fitments such that the body may be folded into a more compact form for shipping/logistics purposes.

In some embodiments, the apertures are sized to comfortably receive cable connections therethrough, typically between one quarter inch and one inch in diameter, though apertures of smaller or larger diameters may be used as appropriate to a particular cable assembly and/or cable assembly connectors.

In some embodiments, apparatus or fixtures according to some embodiments are configured to be broken down (disassembled) into two, three or more parts to facilitate storing the apparatus/fixture in smaller case(s) and/or creating a smaller footprint in real-world applications. To ensure the boards do not slip and create gaps within the measurement, small latches may be formed or disposed upon the body of the apparatus/fixtures.

In some embodiments, the edges of the apertures A may be coated with a resilient or cable-safe material such as silicon, rubber, polymer and the like so as to configure the apertures to provide a smooth surface to avoid damaging cable assembly connections, wires, fibers and the like passing therethrough. Alternatively, the apertures A may be fitted with grommets formed of silicon, rubber, polymer and the like to achieve this purpose. Other resilient materials, as well as non-resilient materials (e.g., TEFLON® coated materials, steel, etc.) may also be used to achieve this purpose. In some embodiments, the body 1 may comprise movable portions surrounding the apertures so that the apertures A are adjustable in diameter and/or shape.

The various embodiments generally disclose an apparatus configured to enable off-platform presentation of a cable assembly for prior to platform installation of the cable assembly. The apparatus may comprise an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and a retention assembly, configured to secure the cable assembly to the retention assembly and/or the first surface in a manner allowing mechanical manipulation of the cable assembly; wherein the cable assembly is configured for platform installation when secured to the retention assembly and/or the first surface such that cable connections and corresponding apertures are operatively aligned.

The apparatus may be configured to be operatively engaged with the platform such that the cable assembly connections are located proximate respective corresponding platform connections. The apparatus may be configured to release the cable assembly such that the apparatus may be withdrawn from the platform after installation of the cable assembly on the platform. The proximal and distal ends of the body may correspond to, respectively, fore and aft platform orientations of the cable assembly.

The apparatus may further comprise a second surface 20 disposed between the proximal and distal ends of the body 1 and configured to have secured thereupon a second retention assembly configured as discussed above with respect to the retention assembly 2. The second retention assembly receiving thereupon a second cable assembly, the second surface 20 being substantially coplanar with the first surface 10 such that the plurality of apertures formed therethrough are arranged in accordance with a spacing of cable connections of the second cable assembly.

The retention assembly may comprise an elongated member aligned along the elongated planar body and pivotally secured to the elongated planar body. The retention assembly may have formed therethrough a plurality of apertures arranged in accordance with a spacing of cable mounting connections suitable for securing the cable assembly. The retention assembly elongated member may be sized as between 20% and 50% of the length of the elongated planar body.

The retention assembly may comprise a plurality of top portions configured to receive thereupon respective sections of a cable assembly, each top portion being pivotably mounted to a respective standoff, each standoff being mounted to the first surface or to a base plate mounted to the first surface. The retention assembly may further comprise a locking mechanism configured to lock the top portions in a substantially 90 degree pivot position. The locking mechanism may comprise at least one rod slidably engaged with a respective top portion and, in a locking mode of operation, extending from the respective top portion to a slot formed through the first surface and/or the baseplate.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. An apparatus configured to enable off-platform presentation of a cable assembly for prior to platform installation of the cable assembly, the apparatus comprising:
an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and
a retention assembly, configured to temporarily secure the cable assembly to the first surface in a manner allowing mechanical manipulation of the cable assembly;
wherein the cable assembly is configured for platform installation when secured to the first surface such that cable connections and corresponding apertures are operatively aligned.

2. The apparatus of claim 1, wherein the apparatus is configured to be operatively engaged with the platform such that the cable assembly connections are located proximate respective corresponding platform connections.

3. The apparatus of claim 1, wherein the retention assembly is further configured to release the cable assembly such that the apparatus may be withdrawn from the platform after installation of the cable assembly on the platform.

4. The apparatus of claim 1, wherein the proximal and distal ends of the body correspond to, respectively, fore and aft platform orientations of the cable assembly.

5. The apparatus of claim 1, wherein the apparatus further comprises a second surface disposed between the proximal and distal ends of the body configured to receive thereupon a second cable assembly, the second surface being substantially coplanar with the first surface such that the plurality of apertures formed therethrough are arranged in accordance with a spacing of cable connections of the second cable assembly.

6. The apparatus of claim 1, wherein the retention assembly comprises an elongated member aligned along the elongated planar body and pivotally secured to the elongated planar body.

7. The apparatus of claim 6, wherein the retention assembly has formed therethrough a plurality of apertures arranged in accordance with a spacing of cable mounting connections suitable for securing the cable assembly.

8. The apparatus of claim 6, wherein the retention assembly elongated member is between 20% and 50% of the length of the elongated planar body.

9. The apparatus of claim 6, wherein the retention assembly comprises:
a plurality of top portions configured to receive thereupon respective sections of a cable assembly, each top portion being pivotably mounted to a respective standoff, each standoff being mounted to the first surface.

10. The apparatus of claim 9, wherein the retention assembly further comprises a locking mechanism configured to lock the top portions in a substantially 90 degree pivot position.

11. The apparatus of claim 10, wherein the locking mechanism comprises at least one rod slidably engaged with a respective top portion and, in a locking mode of operation, extending from the respective top portion to a slot formed through the first surface.

12. The apparatus of claim 6, wherein the retention assembly comprises:
a plurality of top portions configured to receive thereupon respective sections of a cable assembly, each top portion being pivotably mounted to a respective standoff, each standoff being mounted to a base plate, the base plate being secured to the first surface.

13. The apparatus of claim 12, wherein the retention assembly further comprises a locking mechanism configured to lock the top portions in a substantially 90 degree pivot position.

14. The apparatus of claim 13, wherein the locking mechanism comprises at least one rod slidably engaged with a respective top portion and, in a locking mode of operation, extending from the respective top portion to a slot formed through the first surface.

15. A system configured to enable off-platform presentation of a cable assembly for prior to platform installation of the cable assembly, the system comprising:
an elongated and substantially planar body having a first surface disposed between proximal and distal ends of the body and configured to receive thereupon the cable assembly, the first surface having formed therethrough a plurality of apertures arranged in accordance with a spacing of cable connections of the cable assembly; and
a retention assembly, configured to secure the cable assembly to the first surface in a manner allowing mechanical manipulation of the cable assembly;
wherein the cable assembly is configured for platform installation when secured to the first surface such that cable connections and corresponding apertures are operatively aligned.
